(19) United States
(12) Patent Application Publication
(10) Pub. No.: US 2008/0277549 A1
(43) Pub. Date: Nov. 13, 2008

(54) Beam Flange Clamp

(76) Inventor: James Laurence Curtin, Sydney (AU)

Correspondence Address: JACOBSON & JOHNSON, ONE WEST WATER STREET, SUITE 285, ST. PAUL, MN, 55107, US

(21) Appl. No.: 11/547,291

(22) PCT Filed: Jun. 17, 2005
(86) PCT No.: PCT/AU2005/000866

§ 371 Date: Oct. 2, 2006

(30) Foreign Application Priority Data
Jun. 18, 2004 (AU) 2004903323

(51) Int. Cl. F16B 1/00

(52) U.S. Cl. 248/228.3

(57) ABSTRACT

There is a clamp for a universal beam (18). The clamp includes a flange hook (1) and locking plate (8) which are disposed on a support bar (2) for relative slidable adjustment over a range of beam configurations. In a position of use the clamp is attached to the beam (18) by slidable adjustment of the flange hook (1) and locking plate (8) to engage respective beam flanges (19, 20) in a manner to obtain a rigid load bearing beam mounting for the support bar (2).

### FIELD OF THE INVENTION

This invention relates to builders' equipment. More particularly, although not exclusively, it discloses a universal beam (UB) flange clamp for safety barriers.

### BACKGROUND TO THE INVENTION

In building construction a safety barrier must be fitted around elevated deck structures before the floor or other work can commence. While a variety of brackets are known for attaching the barrier posts to wooden structural members these existing devices do not fit exposed deck edges which are defined by universal beams. Such beams are commonly used in elevated decks where an extended clear span is required. It is normal practice with universal beams to erect conventional scaffolding from the ground up which is laborious and expensive. It is also known to fashion brackets by fitting straps around the universal beams. These devices however have to be custom made for each beam size and are time consuming and costly to fit.

### SUMMARY OF THE INVENTION

It is therefore an object of this invention to ameliorate the aforementioned disadvantage and accordingly a clamp for a universal beam is disclosed, said clamp including a hook means and one or more locking plates which are disposed on a support bar and adapted for relative slidable adjustment over a range of beam configurations whereby in use said clamp can be attached to said beam by said slidable adjustment to engage respective beam flange edges with the hook means and said one or more locking plates in a manner to obtain a rigid load bearing beam mounting for said support bar.

Preferably the hook means comprises a pair of wedge shaped slots which face along said bar in the direction of said one or more locking plates.

It is further preferred that the hook means is fixed to the bar and said one or more locking plates are adapted for said slidable adjustment.

It is further preferred that the support bar includes a mounting for a safety barrier post.

### BRIEF DESCRIPTION OF THE DRAWINGS

The invention will be further described with reference to the attached drawings in which:

FIG. 1 is a schematic perspective view of a first embodiment of a beam flange clamp according to this concept,

FIG. 2 shows a reversible adjuster for use with the clamp of FIG. 1,

FIG. 3 shows the clamp of FIG. 1 when fitted across the underside of an unmodified universal beam,

FIGS. 4 to 8 show elevation views of the clamp of FIG. 1 when adapted for use with modified configurations of universal beam,

FIG. 9 shows a second embodiment of a beam flange clamp according to the invention, and

FIG. 10 shows the clamp of FIG. 9 when fitted across the end of a universal beam.

### DETAILED DESCRIPTION OF THE PREFERRED EMBODIMENTS

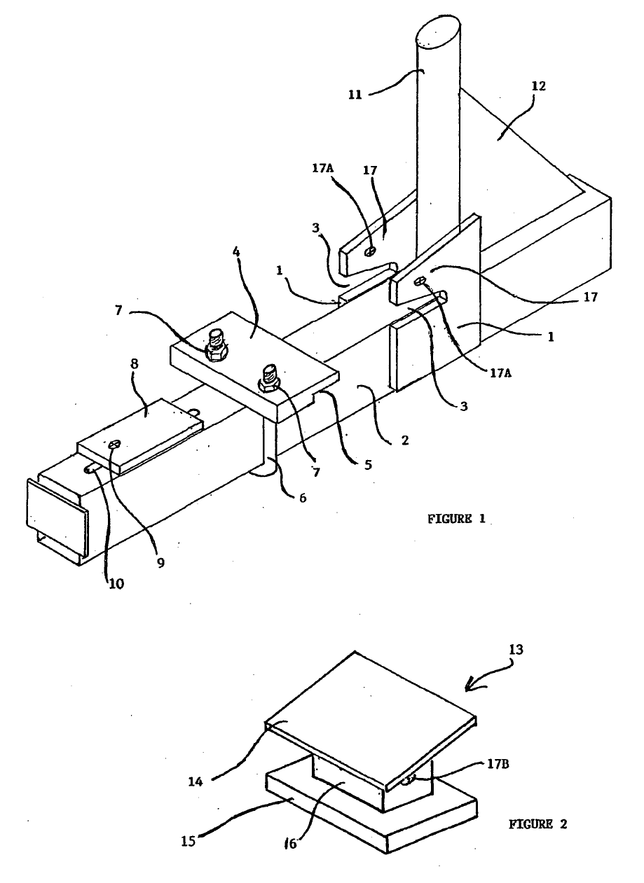

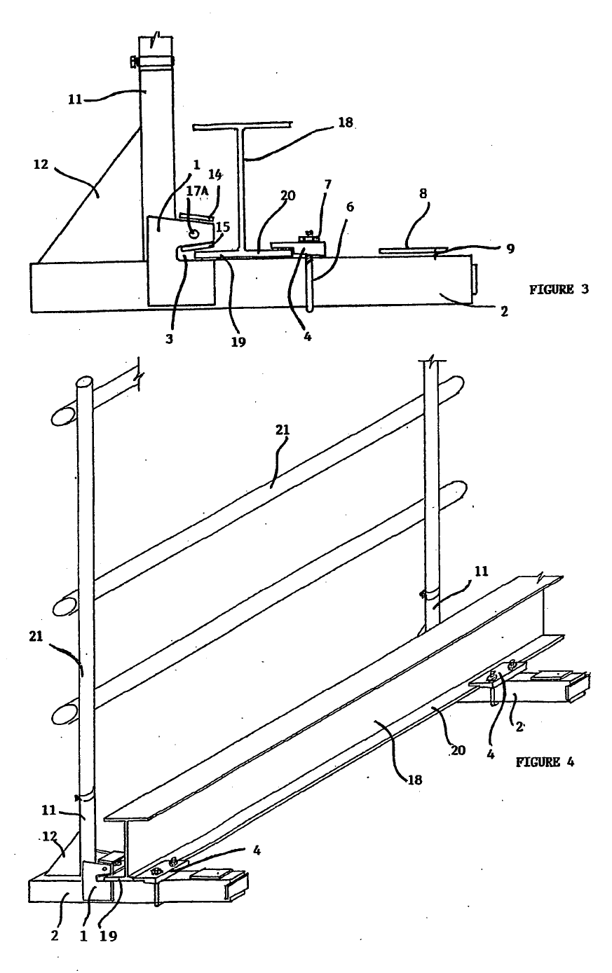

Referring first to FIG. 1 there is a clamp comprising a pair of aligned flange hooks 1 rigidly mounted to the sides of a support bar 2. While with this embodiment the bar preferably comprises a 75×50×3 RHS the invention is not limited to this and extends to any other suitable type of structural member. The flange hooks preferably include wedge shaped slots 3 which face along the length of the bar 2 toward a rectangular locking plate 4 with a stepped inner edge 5. This plate is mounted to the upper face of the bar by a U bolt 6 which can be tightened by nuts 7 to secure said plate over a range of positions relative to the flange hooks 1. The clamp can thus be adjusted to suit a range of sizes of universal beam. There is also a slider plate 8 with pin 9 which is movable in a channel 10 adjacent one end of the bar and a vertical post support sleeve 11 with reinforcing gusset 12 adjacent the other end. While the clamp of this embodiment is suitable for use with 200 to 410 universal beams as commonly used by builders the dimensions may be varied within the scope of this invention to suit other sizes. In particular the slot openings 3 preferably exceed the unmodified flange thickness of such beam and an adjuster insert 13 is therefore provided as shown in FIG. 2. This comprises a pair of spacer plates 14 and 15 of different thicknesses (in this case 6 mm and 10 mm) which are inclined relative to one another on opposite sides of a connector block 16. The insert is shaped and dimensioned to fit onto the upper jaws 17 of the flange hook so that either plate 14 or 15 can be positioned within the slots 3 to reduce their effective width. The insert is preferably held in place by a pin fitted through aligned apertures 17A and 17B in the jaws and connector block.

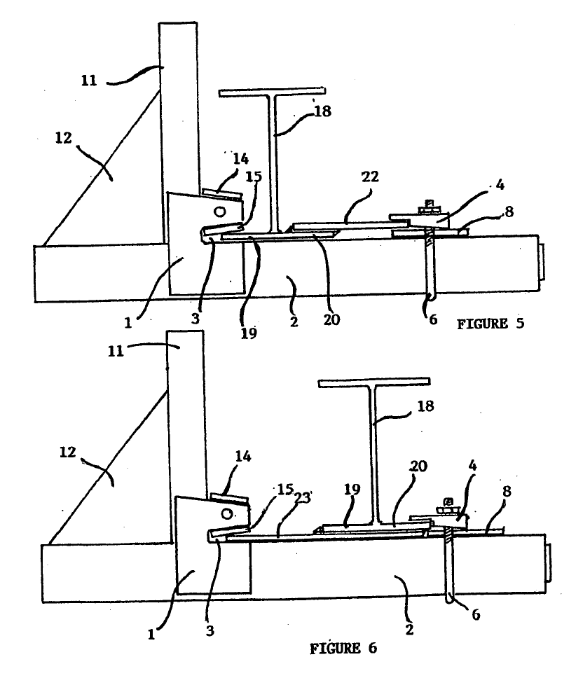

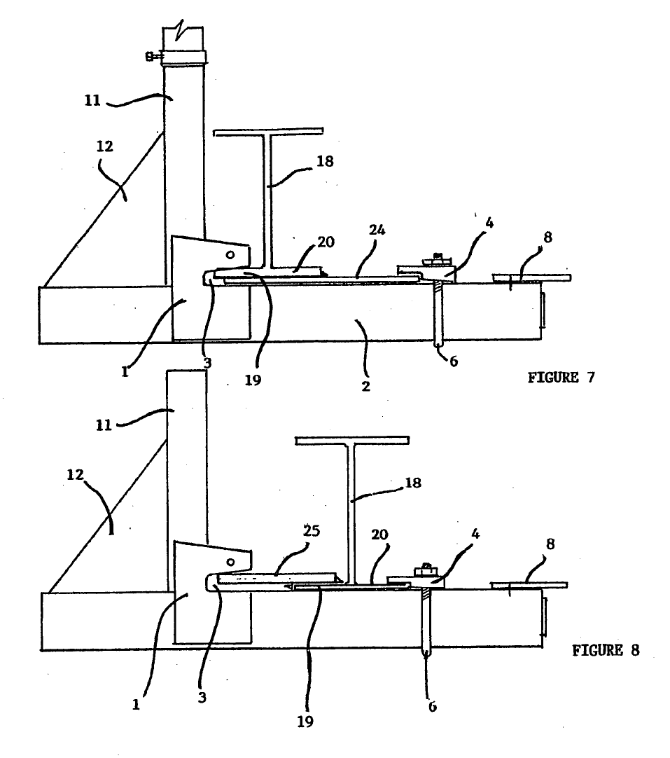

Referring now to FIG. 3 two clamps as described above are shown fitted to an unmodified universal beam 18. One bottom flange 19 is push fitted into the hook slots 3 and the opposite bottom flange 20 is gripped under the stepped edge 5 of the locking plate 4 which has been slid over hard against said beam and then tightened in place using the U bolt 6. It will be noted that the aforementioned adjuster with spacer plates 14, 15 has also been fitted to the flange hooks to enable a secure grip on the unmodified beam flange. As shown in FIG. 4 the arrangement thus provides a rigid beam mounting for the bar so that the vertical sleeve 11 can function as a load bearing post support for a safety barrier 21 along the length of said beam.

In order to accomodate the thicker edges of modified beams where plates 22 to 25 have been welded to the flanges 19, 20 the aforementioned slider plate 8 can also be positioned under the locking plate 4 or the adjuster 13 removed to increase the effective width of the slots 2 as shown in FIGS. 5 to 8.

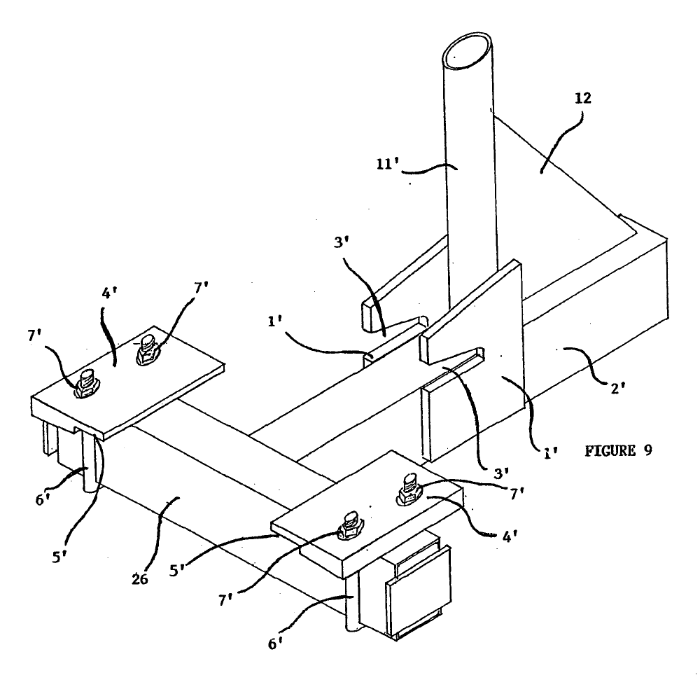

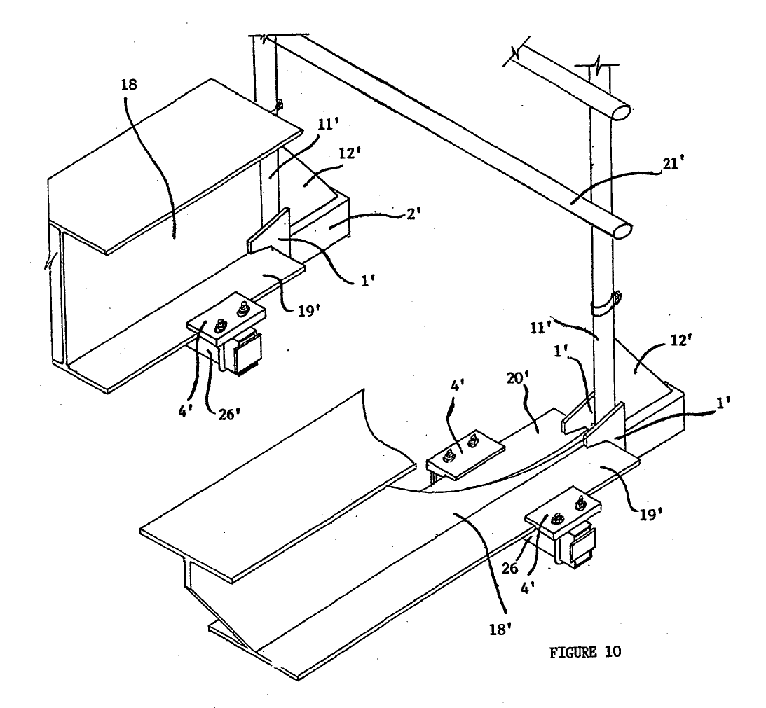

With the second embodiment of the invention shown in FIGS. 9 and 10 the main components that correspond in function to those of FIGS. 1 to 8 are identified by the same numbers which however are primed (′) to distinguish them. In this case the clamp is adapted for attachment across the end of the beam 18′. It includes a pair of opposed locking plates 4′ which are slidably mounted on a cross-bar 26 welded across the end of the support bar 2′. The clamp is shown in a position of use in FIG. 10 where for the purpose of illustration part of the end of one of the beams has been cut away. The flange hooks 1′ engage the ends of the lower beam flanges 19′, 20′ while the locking plates are slid inward on the cross-bar 26 to grip the sides of said flanges. By fitting such clamp to adjacent beams as shown a safety barrier support structure across the ends of said beams is provided.

It will thus be appreciated that this invention at least in the form of the embodiments disclosed provides a novel flange clamp for fixing barrier posts onto a range of sizes of universal beam. Clearly however the examples disclosed are only the currently preferred forms of the invention and a variety of modifications may be made which would be apparent to a person skilled in the art. For example the shape and configuration of the flange hooks, support bar and locking plates may be changed according to design preference or following further development work by the inventor. Also while it is currently preferred to construct the clamp from structural grade steel the invention extends to the use of any other suitable material.

The claims defining the invention are as follows:

1. A clamp for a universal beam, said clamp including a hook means and one or more locking plates which are disposed on a support bar and adapted for relative slidable adjustment over a range of beam configurations whereby in use said clamp can be attached to said beam by said slidable adjustment to engage respective beam flanges with the hook means and said one or more locking plates in a manner to obtain a rigid load bearing beam mounting for said support bar.

2. The clamp as claimed in claim 1 wherein said hook means include a pair of wedge shaped slots which face along said support bar in the direction of said one or more locking plates.

3. The clamp as claimed in claim 1 wherein the hook means is fixed to the bar and said one or more locking plates are adapted for said slidable adjustment.

4. The clamp as claimed in claim 1 wherein the support bar includes a mounting for a safety barrier post.

5. The clamp as claimed in claim 1 wherein said clamp includes a slider plate which can be positioned under said one or more locking plates to improve beam engagement when said universal beam has beam flanges of reduced thickness.

6. The clamp as claimed in claim 1 wherein said clamp includes an adjuster insert for use when a slot opening of the hook means exceeds the flange thickness of said beam, said insert including a pair of spacer plates which are inclined relative to one another on opposite sides of a connector member, said insert being shaped and dimensioned to fit into one or more jaws of said hook means to reduce the effective width thereof.

7. The clamp as claimed in claim 1 wherein there are a pair of opposed locking plates which are slidably mounted on a cross-bar affixed across an end of the support bar whereby in use said hook means engages the ends of the lower flanges of said beam and said locking plates are positioned on said cross-bar to grip the sides of said lower flanges.

8. The clamp as claimed in claim 7 whereby said hook means include a pair of wedge shaped slots which face along said support bar.

9. The clamp as claimed in claim 7 wherein the support bar includes a mounting for a safety barrier post adjacent said hook means.

10. A safety barrier when fitted to a structure using the clamp as claimed in claim 1.
